(19) United States
(12) Patent Application Publication
(10) Pub. No.: US 2026/0357946 A1
(43) Pub. Date: Nov. 12, 2026

(54) STAND FOR A POWER TOOL

(71) Applicant: MILWAUKEE ELECTRIC TOOL CORPORATION, Brookfield, WI (US)

(72) Inventors: Madeleine Pena Medrano, Pewaukee, WI (US); Ian C. Richards, Shorewood, WI (US); Daryl S. Richards, Sussex, WI (US); Kevin A. McLachlan, Brookfield, WI (US); Alicia G. Rothenberg, Milwaukee, WI (US); Mason B. Lehman, South Whitley, IN (US); Katherine A. Flaherty, Brookfield, WI (US); John P. Carroll, Brookfield, WI (US)

(21) Appl. No.: 19/678,001

(22) Filed: May 14, 2026

Related U.S. Application Data
(60) Provisional application No. 64/023,042, filed on Mar. 31, 2026.
(60) Provisional application No. 63/887,637, filed on Sep. 25, 2025.
(60) Provisional application No. 63/804,150, filed on May 12, 2025.

(51) Int. Cl. F16M 11/28; F16M 11/04; F16M 11/10; F16M 11/20; H02G 1/08

(52) U.S. Cl. CPC F16M 11/28; F16M 11/041; F16M 11/10; F16M 11/2021; H02G 1/081; F16M 2200/024

(57) ABSTRACT

A stand for use with a power tool includes a foot positioned at a first end of the stand and a head positioned at a second end of the stand. The head includes a tool attachment member defining a tool engagement axis. The tool attachment member selectively couples to the power tool along the tool engagement axis. The stand includes a first extension member coupled to the foot and a second extension member coupled to the first extension member. The second extension member extends away from the first extension member. The second extension member is selectively extendable and retractable with respect to the first extension member.

### CROSS-REFERENCE TO RELATED APPLICATIONS

This application claims priority to U.S. Provisional Application No. 63/804,150, filed May 12, 2025, to U.S. Provisional Application No. 63/887,637, filed Sep. 25, 2025, and to U.S. Provisional Application No. 64/023,042, filed Mar. 31, 2026, the entire contents of all of which are incorporated by reference herein.

### FIELD

The present disclosure relates to a stand accessory, and more particularly to a stand accessory for a cable puller.

### BACKGROUND

A cable puller can be used for pulling electrical cable through a conduit in a building from a feeding area to a pulling area, for example. A rope can be attached to an end of the cable and the rope is initially fed through the conduit at the feeding area and wrapped around a capstan of the cable puller in the pulling area, which is rotated to create tension in the rope and pull the cable through the conduit.

### SUMMARY

The disclosure provides, in one aspect, a stand for use with a power tool. The stand includes a first end and a second end opposite the first end. The stand includes a foot positioned at the first end of the stand. The foot rests on a support surface. The stand includes a head positioned at the second end of the stand. The head includes a tool attachment member defining a tool engagement axis. The tool attachment member selectively couples to the power tool along the tool engagement axis such that the stand supports the power tool at a height with respect to the foot. The stand includes a first extension member coupled to the foot and a second extension member coupled to the first extension member. The second extension member extends away from the first extension member. The second extension member is selectively extendable and retractable with respect to the first extension member.

In some examples, the stand includes a pivot joint positioned between the first extension member and the foot or positioned between the second extension member and the head. The pivot joint selectively adjusts a position of the head and/or an angle of the tool engagement axis relative to the foot.

The disclosure provides, in another aspect, a stand for a power tool. The stand includes a first end and a second end opposite the first end. The stand includes a foot positioned at the first end of the stand. The foot rests on a support surface. The stand includes a first extension member coupled to the foot and extending away from the foot. The stand includes a second extension member coupled to the foot and extending away from the foot. The second extension member is selectively moveable with respect to the first extension member. The stand includes a head coupled to the second extension member and positioned at the second end of the stand. The head includes a tool attachment member defining a tool engagement axis. The tool attachment member selectively couples to the power tool along the tool engagement axis such that the stand supports the power tool at a height with respect to the support surface.

In some examples, the stand includes an intermediate extension member coupled to the first extension member and extending away from the first extension member. The intermediate extension member is selectively extendable and retractable with respect to the first extension member. The second extension member is coupled to the intermediate extension member and extends away from the intermediate extension member. The second extension member is selectively extendable and retractable with respect to the intermediate extension member. The second extension member is selectively extendable and retractable with respect to the first extension member.

The disclosure provides, in another aspect, a stand for a power tool. The stand includes a first end and a second end opposite the first end. The stand includes a foot positioned at the first end of the stand. The foot rests on a support surface. The stand includes a first pivot joint closer to the first end than to the second end. The stand includes an extension pole coupled to the foot via the first pivot joint such that the extension pole is selectively pivotable relative to the foot. The stand includes a second pivot joint closer to the second end than to the first end. The stand includes a head coupled to the extension pole via the second pivot joint such that the head is selectively pivotable relative to the extension pole. The head includes a tool attachment member defining a tool engagement axis. The tool attachment member selectively couples to the power tool along the tool engagement axis such that the stand supports the power tool at a height with respect to the support surface. The first pivot joint and the second pivot joint are operable to select a position of the tool attachment member and an angle of the tool engagement axis relative to the foot.

The disclosure provides, in another aspect, a stand for a power tool. The stand includes a first end and a second end opposite the first end. The stand includes a foot positioned at the first end of the stand. The foot rests on a support surface. The stand includes a first extension member coupled to the foot and extending away from the foot. The stand includes a second extension member coupled to the first extension member and extending away from the first extension member. The second extension member is selectively extendable and retractable with respect to the first extension member. The stand includes a head coupled to the second extension member and positioned at the second end of the stand. The head includes a tool attachment member defining a tool engagement axis along which a socket of the power tool engages the tool attachment member. The tool attachment member selectively couples to the power tool along the tool engagement axis such that the stand supports the power tool at a height with respect to the support surface. The head includes a housing at least partially enclosing a locking mechanism positionable in a locked position and in an unlocked position. The locking mechanism includes a longitudinal slide that slides parallel to the tool engagement axis and a transverse slide that slides transverse to the tool engagement axis to selectively position the longitudinal slide in the locked position or the unlocked position.

Other features and aspects of the disclosure will become apparent by consideration of the following detailed description and accompanying drawings.

### BRIEF DESCRIPTION OF THE DRAWINGS

FIG. 1 is a front view of a cable puller system of the present disclosure.

FIG. 2 is a front view of a stand of the cable puller system of FIG. 1 according to one aspect of the disclosure.

FIG. 3 is a perspective side view of a bottom pivot joint of the stand of FIG. 2 according to one aspect of the disclosure.

FIG. 4 is a side section view of the bottom pivot joint of the stand of FIG. 2 along the line 4-4 of FIG. 3.

FIG. 5 is a front view of the stand of FIG. 2 showing a plurality of angles to which the bottom pivot joint is rotatable.

FIG. 6A is a front view of the stand in an extended position.

FIG. 6B is a front view of the stand in a retracted position.

FIG. 7A is a side view of a height adjustment mechanism of the stand of FIG. 2 according to one aspect of the disclosure.

FIG. 7B is a side section view of the height adjustment mechanism of FIG. 7A along the line 7B-7B of FIG. 7A.

FIG. 8A is a side view of the stand of FIG. 2, similar to the side view of FIG. 7A.

FIG. 8B is a side section view of the height adjustment mechanism of FIGS. 7A and 8A along the line 8B-8B of FIG. 8A.

FIG. 9 is a rear perspective view of a top pivot joint of the stand of FIG. 2 according to one aspect of the disclosure.

FIG. 10 is a side section view of the top pivot joint of FIG. 9 along the line 10-10 of FIG. 9.

FIG. 11 is a front view of the cable puller system of FIG. 1 showing the top pivot joint rotated to a plurality of angles to support a cable puller at the plurality of angles.

FIG. 12 is a side perspective view of a tool attachment member of the stand of FIG. 2.

FIG. 13 is a side section view of the tool attachment member of FIG. 12 along the line 10-10 of FIG. 12 and also showing a socket of a tool coupled to the tool attachment member.

FIG. 14 is a perspective view of a bottom pivot joint of the stand of FIG. 2 according to one aspect of the disclosure.

FIG. 15 is a section view of the bottom pivot joint of FIG. 14 along the line 15-15 of FIG. 14.

FIG. 16 is a front view of the stand of FIG. 2 showing the bottom pivot joint of FIG. 14 rotated to different angles.

FIG. 17 is a front perspective view of a top pivot joint of the stand of FIG. 2 according to another aspect of the disclosure.

FIG. 18 is a cross-section view of the top pivot joint of FIG. 17 along a line 18-18 of FIG. 17 showing a locking mechanism in a first position.

FIG. 19 is a cross-section view of the top pivot joint of FIG. 17 along the line 18-18 showing the locking mechanism of FIG. 18 in a second position.

FIG. 20 is a front perspective view of a top pivot joint of the stand of FIG. 2 according to another aspect of the disclosure.

FIG. 21 is a cross-section view of the top pivot joint of FIG. 20 along the line 21-21 showing a cam handle.

Before any embodiments of the disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

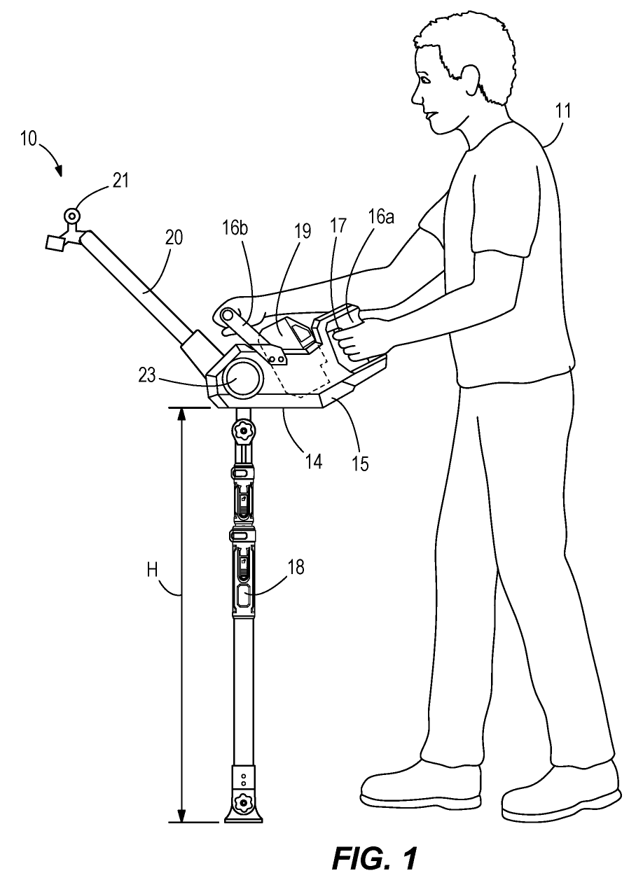

FIG. 1 illustrates a cable puller system 10 including a cable puller 14 and a stand 18 (e.g., a base or support). The stand 18 is a stand for a power tool and may be a telescoping tube stand 18. The cable puller 14 can be used to pull electrical cable through a conduit from a feeding area to a pulling area. The cable puller 14 includes a housing 15. The cable puller 14 includes handles 16a, 16b, an actuator such as a trigger 17 for operating the cable puller 14, a boom 20 extending from the housing 15, and a pulley or roller 21 to facilitate retracting a rope, wire, and/or cable. The rope, wire, and/or cable may be wrapped around a capstan 23 during a retraction operation. The handles 16a, 16b may include further actuators (e.g., buttons) that may allow the user to control the cable puller 14 (e.g., to control characteristics of the cable puller 14 such as speed, rotation direction, etc.).

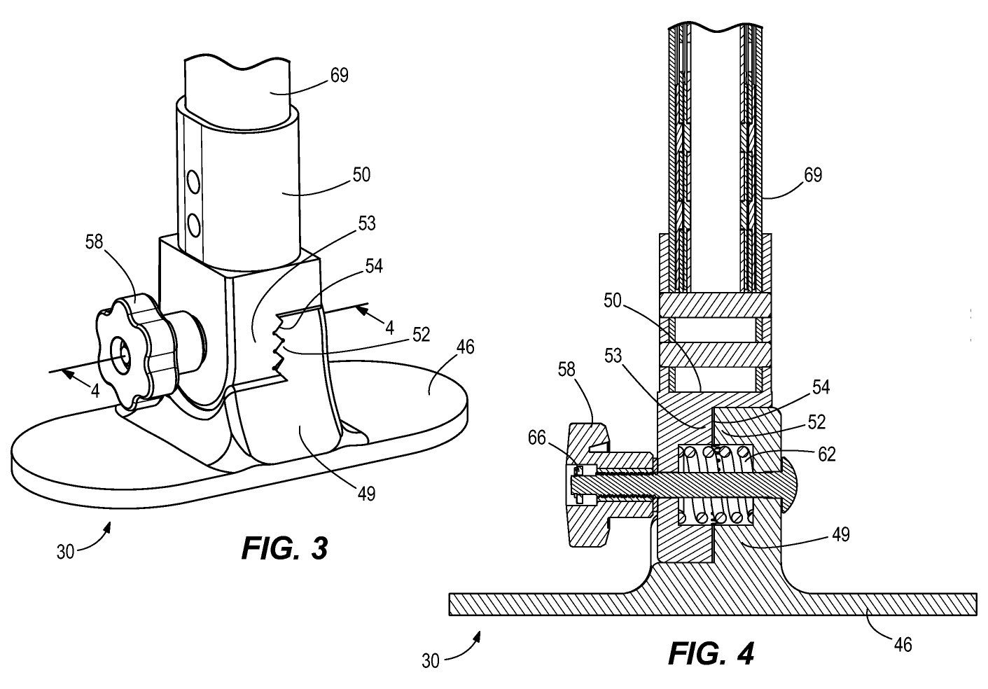

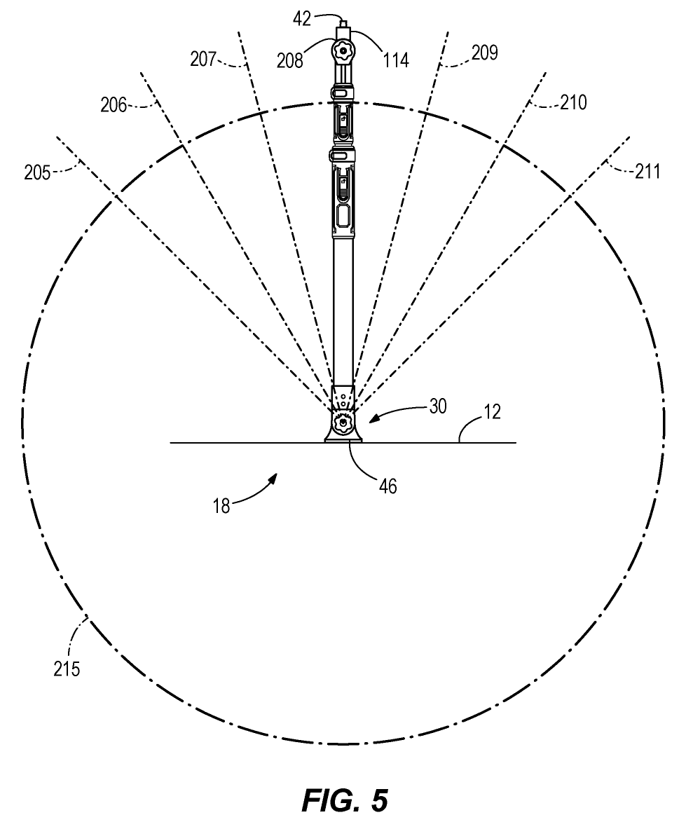

With continued reference to FIG. 1, the cable puller 14 may be battery powered. For example, a battery-powered cable puller 14 may include an onboard battery pack 19 received in a battery receptacle at least partially defined by the housing 15 of the cable puller 14. The battery pack 19 may be rechargeable and may be interchangeable with other battery packs 19 and may be usable with other power tools such as power drills, saws, grease guns, fish tape tools, radios, coolers, etc. The cable puller 14 may be a handheld cable puller 14. The stand 18 is removably coupled to the cable puller 14. The stand 18 allows a user 11 to stabilize the cable puller 14 on a support surface 12 (e.g., the ground; see FIG. 5) and reduce the majority of tool weight supported by the user 11 during a cable pulling operation. As discussed in detail below, the stand 18 is a telescoping stand that allows the user 11 to change a height H of the cable puller 14 relative to a foot 46 (see FIGS. 3 and 4). In some embodiments, the cable puller 14 can be exchanged for a variety of other handheld power tools.

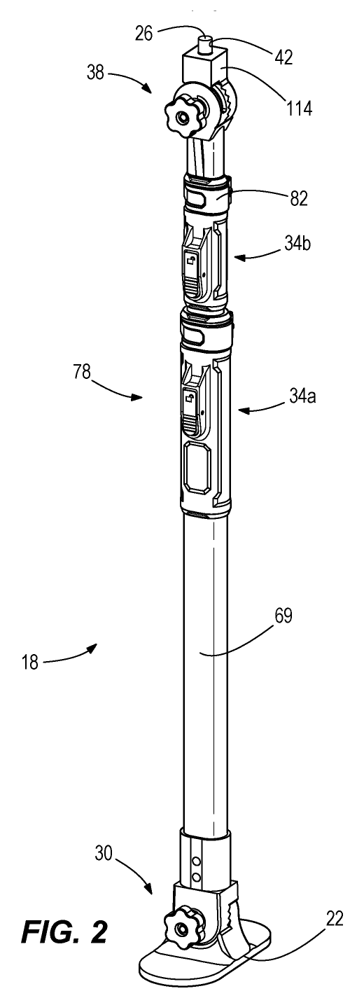

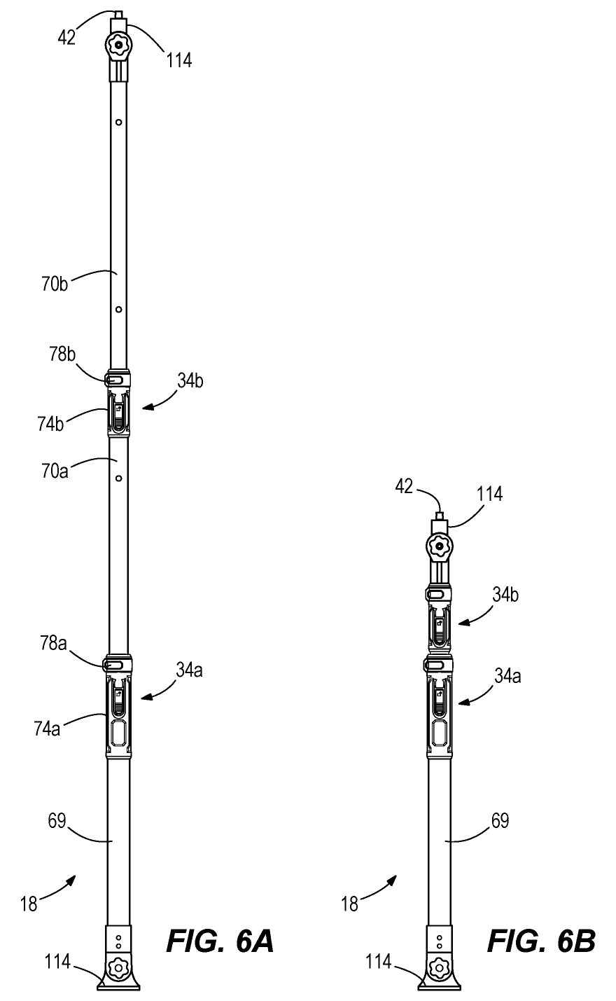

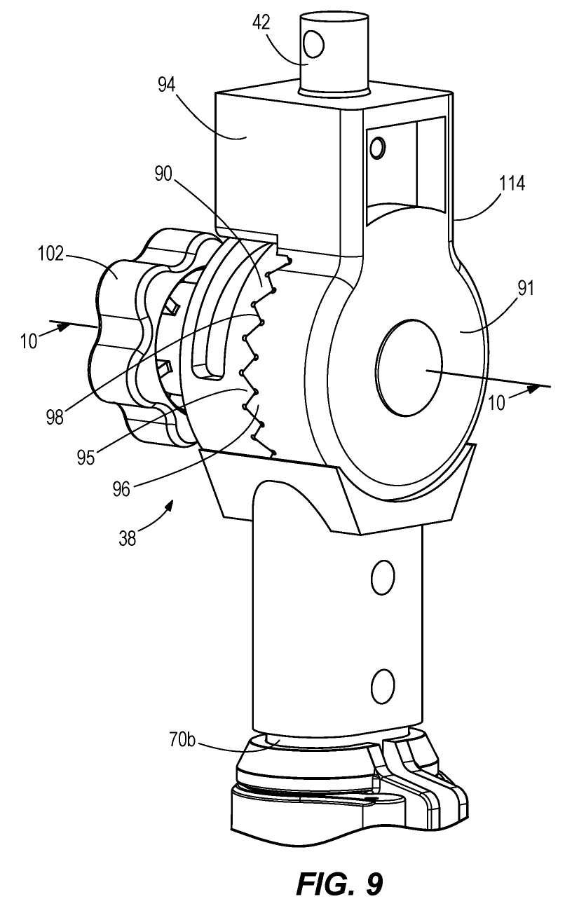

With reference to FIG. 2, the stand 18 includes a bottom end 22 (e.g., a first end) that may be placed on or otherwise adjacent to the support surface 12 and a top end 26 (e.g., a second end) opposite the bottom end 22 and adjacent the cable puller 14. The bottom end 22 of the stand 18 may rest on the support surface 12. The stand 18 further includes a foot positioned at the bottom end 22 of the stand 18, a bottom pivot joint 30 (e.g., a first pivot joint), a first extension member 69, a first (or intermediate) height adjustment system 34a (e.g., a lower height adjustment system 34a) including an intermediate extension member 70a (FIG. 6A), a second height adjustment system 34b (e.g., an upper height adjustment system 34b) including a second extension member 70b (FIG. 6A), a top pivot joint 38 (e.g., a second pivot joint), and a head 114 including a tool attachment member 42 for coupling the stand 18 to a power tool such as the cable puller 14. In some embodiments, the stand 18 may not include the bottom pivot joint 30 and/or may not include the top pivot joint 38. The bottom pivot joint 30 may be positioned at the bottom end 22 of the stand 18, and the tool attachment member 42 may be positioned at the top end 26 of the stand 18. In some embodiments, the bottom pivot joint 30 may be cantilevered as shown, for example, in FIG. 3, and the top pivot joint 38 may similarly be cantilevered as shown, for example, in FIG. 9.

With reference to FIGS. 3 and 4, the foot 46 may in some embodiments be formed as a foot plate 46 having a lower (i.e., first) joint body 49. The foot 46 is configured to rest on the support surface 12. In some embodiments, the foot 46 may include a piece of rubber such as a rubber cap. In some embodiments, the foot 46 may be molded into a lower end of the first extension member 69. For example, in some embodiments, the foot 46 may include a rubber cap that may be molded into a lower end of the first extension member 69. The foot 46 may be pivotably attached to a first extension member 69 (e.g., a first pole, a first telescoping pole, a first fixed pole, etc.) via the bottom pivot joint 30, which couples the lower (i.e., first) joint body 49 to an upper (i.e., second) joint body 50. In some embodiments, the foot 46 may be attached to the first extension member 69 with fasteners (e.g., screws, rivets, etc.) as two separate parts. The first joint body 49 and the second joint body 50 are attached to each other at the bottom pivot joint 30 which, in some embodiments, includes a hirth joint 54 to allow the second joint body 50 to pivot relative to the foot plate 46. A hirth joint may be an incrementally adjustable joint. A hirth joint may include teeth. In some embodiments, the bottom pivot joint 30 may include teeth, and in some embodiments, the bottom pivot joint 30 may not include teeth. More specifically, the bottom pivot joint 30 may include a friction joint having teeth, and in some embodiments, the bottom pivot joint 30 may include a friction joint not having teeth. Pivoting the second joint body 50 pivots a remainder of the stand 18 (e.g., the first extension member 69, the height adjustment mechanisms 34a, 34b, etc.) relative to the support surface 12. The hirth joint 54 includes a first joint member 52 integrally formed with the first joint body 49 and a second joint member 53 integrally formed with the second joint body 50. In some embodiments, the first joint member 52 may be attached to the first joint body 49 in other ways, and the second joint member 53 may be attached to the first joint body 50 in other ways. The first joint member 52 includes a first face having teeth (e.g., triangular teeth), and the second joint member 53 includes a second face having teeth (e.g., triangular teeth) that are selectively engaged with each other at a plurality of angles. The triangular teeth on the first joint member 52 and the second joint member 53 allow the first and second joint members 52, 53 to self-center.

With continued reference to FIG. 4, the bottom pivot joint 30 includes a hand knob 58 that allows a user to pivot the second joint body 50 relative to the foot plate 46 without the use of a tool. Turning the hand knob 58 in a first direction loosens the hirth joint 54. When the hirth joint 54 is loosened, a spring 62 positioned in the hirth joint 54 self-separates and pushes the first joint member 52 and the second joint member 53 apart such that they are disengaged. When the joint members 52, 53 are disengaged, the second joint member 53, which is attached to the second joint body 50, can be rotated relative to the first joint member 52, which is attached to the foot plate 46. Once the second joint member 53 is rotated to the desired position, the user 11 can turn the hand knob 58 in a second direction to tighten the hirth joint 54 and engage the first and second joint members 52, 53. The hand knob 58 may include a travel limit retaining ring 66 which limits the rotation of the hand knob 58. The retaining ring 66 may inhibit the bottom pivot joint 30 from disassembling.

With reference to FIG. 5, the bottom pivot joint 30 allows a remainder of the stand 18 (e.g., the first extension member 69, the height adjustment systems 34a, 34b and/or the tool attachment member 42, etc.) to pivot relative to the support surface 12. More specifically, the bottom pivot joint 30 allows a remainder of the stand 18 (e.g., the height adjustment systems 34a, 34b and/or the tool attachment member 42, etc.) to pivot in a first plane perpendicular to the ground and relative to the foot 46 as shown in FIG. 5. The bottom pivot joint 30 may allow the stand 18 to have a pivot range of 90 degrees between a first extreme position 205 and a second extreme position 211. The first extreme position 205 may be a position of maximum rotation in a first direction (e.g., a counterclockwise direction) in the first plane, and the second extreme position 211 may be a position of maximum rotation in a second direction (e.g., a clockwise direction) in the first plane (i.e., an opposite direction from the first direction) as shown in FIG. 5. The bottom pivot joint 30 may allow a remainder of the stand 18 (e.g., the height adjustment systems 34a, 34b and/or the tool attachment member 42, etc.) to pivot 45 degrees in a clockwise direction and 45 degrees in a counterclockwise direction. The bottom pivot joint 30 may have a set pivot resolution value, such that the user can only pivot the bottom pivot joint 30 in set increments. The bottom pivot joint 30 may have a resolution of 15 degrees such that the user can rotate the bottom pivot joint 30 in 15-degree increments. The bottom pivot joint 30 may be positioned in a central position 208 in which the bottom pivot joint 30 is positioned evenly between the first extreme position 205 and the second extreme position 211. A third position 206 and a fourth position 207 may be positioned between the central position 208 and the first extreme position 205. A fifth position 209 and a sixth position 210 may be positioned between the central position 208 and the second extreme position 211. The bottom pivot joint 30 may allow a remainder of the stand 18 to rotate along a curved path 215 (e.g., a partial arc along a circle).

With reference to FIGS. 6A-8B, the first height adjustment system 34a and the second height adjustment system 34b (FIG. 2) allow the user 11 to change the height H of the stand 18. The height adjustment systems 34a, 34b allow the stand 18 to move between a fully retracted state and a fully extended state and to be positioned in intermediate states of extension therebetween. In some embodiments, the stand 18 may include a single height adjustment system, and in some embodiments, the stand 18 may include more than two height adjustment systems. In the retracted state, the stand 18 may have a height of 2.7 feet or approximately 2.7 feet. In the extended state, the stand may have a height of 5 feet or approximately 5 feet. The height of the stand 18 may be changed in fixed increments. The height adjustment systems 34a, 34b may be operated independently of each other. The first height adjustment system 34a may be positioned in a first fully retracted position (FIG. 6B), a first fully extended position (FIG. 6A), or a plurality of positions therebetween, and the second height adjustment system 34b may be positioned in a second fully retracted position (FIG. 6B), a second fully extended position (FIG. 6A), or a plurality of positions therebetween. The first height adjustment system 34a may be positioned at any position when the second height adjustment system 34b is positioned at any position such that a variety of possible heights H may be obtained.

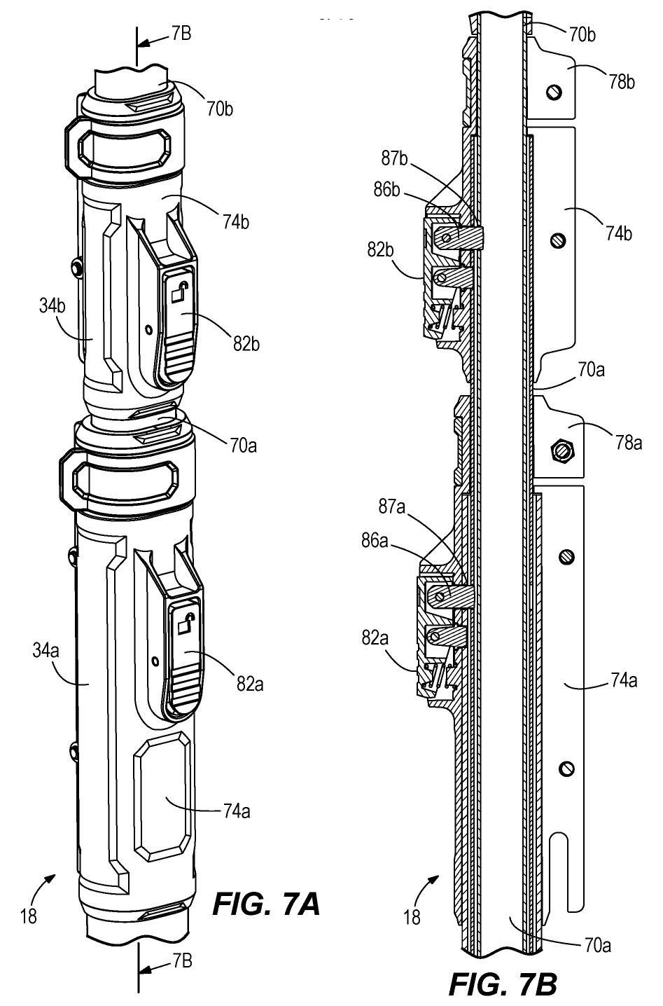

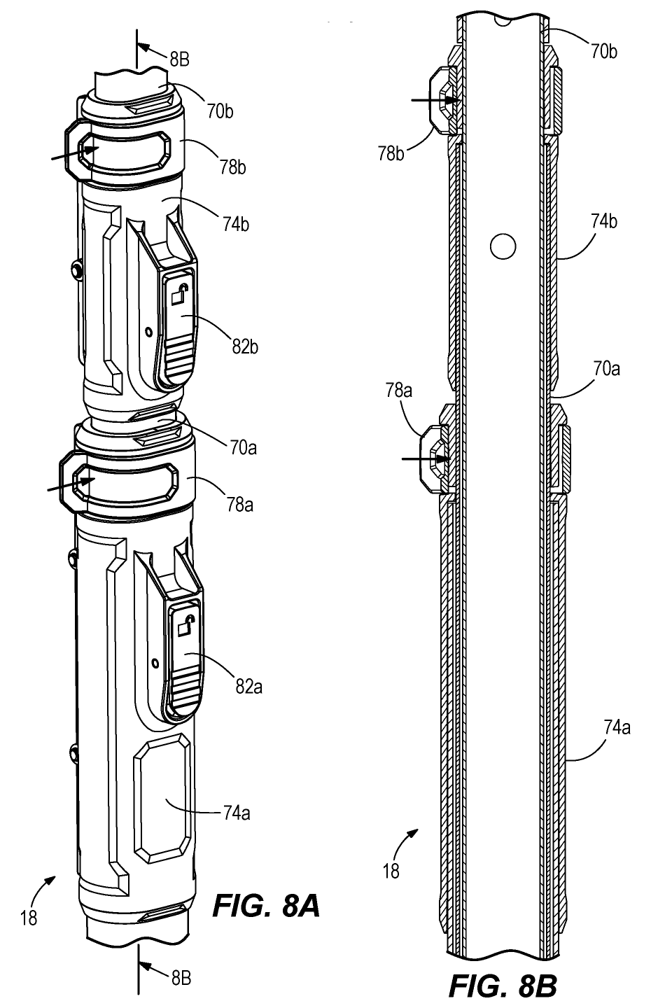

With reference to FIGS. 7A-8B, each height adjustment mechanism 34a, 34b may include a corresponding extension member 70a, 70b, a corresponding position locking mechanism 74a, 74b, and a corresponding friction clamp 78a, 78b positioned on the respective locking mechanism 74a, 74b. The extension members 70a, 70b may be telescoping tubes 70a, 70b, the telescoping tube 70b telescoping into and out of the telescoping tube 70a, and one or both of the telescoping tubes 70a, 70b telescoping into and out of the extension member 69, which may also be a tube to permit telescoping within the extension member 69. The extension member 70a may be nonselectively affixed to the position locking mechanism 74b and movable therewith. The extension member 70b may be nonselectively affixed to the head 114 and movable therewith. The first height adjustment system 34a allows the stand 18 to extend to a first height that is less than the maximum height H and the second height adjustment system 34b allows the stand 18 to extend to a second height that is less than the maximum height H or up to the maximum height H. In some embodiments, the stand 18 may include further height adjustment systems or may only have one height adjustment system. The first and second height adjustment systems 34a, 34b are similar such that only the one height adjustment system 34a is discussed in detail.

As shown in FIGS. 7A and 7B, the position locking mechanism 74a is positioned around the extension member 70a (e.g., the telescoping tube 70a). The position locking mechanism 74a includes a pin 86a that engages with a recess 87a or hole 87a positioned on or in the extension member 70a. The pin 86a is coupled to an actuator 82a such as a button 82a. When the user 11 actuates (e.g., depresses, pushes, etc.) the button 82a, the pin 86a is disengaged from the recess 87a of the extension member 70a such that the extension member 70a can move freely relative to the position locking mechanism 74a. When the user 11 releases the button 82a, the pin 86a engages the recess of the extension member 70a such that the extension member 70a is locked relative to the position locking mechanism 74a. The extension member 70a may have a plurality of recesses 87a spaced incrementally along the extension member 70a such that the height of the stand 18 can be increased incrementally. The recesses 87a may be configured for engagement with the pin 86a. The recesses may be spaced 2 inches apart or approximately 2 inches apart.

With reference to FIGS. 8A and 8B, the friction clamp 78a is attached to the locking mechanism 74a. When the friction clamp 78a is clasped, the extension member 70a (e.g., the telescoping tube 70a) is secured to the locking mechanism 74a. The friction clamp 78a limits (e.g., inhibits) the rattling of the extension member 70a within the locking mechanism 74a. The friction clamp 78b analogously selectively clasps the extension member 70b to the locking mechanism 74b. The friction clamps 78a, 78b may apply a force to the respective extension members 70a, 70b as shown by the arrows in FIGS. 8A and 8B when in a locking position.

In operation, the user 11 may use the height adjustment systems 34a, 34b to change the height H of the stand 18 to obtain a desired height. To use the height adjustment system 34a, a user 11 unclamps the friction clamp 78a attached to the locking mechanism 74a. The user 11 then operates the actuator 82a (e.g., pushes the button 82a) on the locking mechanism 74a. Pressing the button 82a unlocks the extension member 70a by releasing the pin 86a from the extension member 70a such that the user 11 can slide the extension member 70a (e.g., easily slide the extension member 70a) relative to the locking mechanism 74a. The friction clamp 78a inhibits (and in some embodiments may prevent) the extension member 70a from free-falling while the pin 86a is released from the extension member 70a. The user 11 then slides the extension member 70a upward or downward until the pin 86a aligns with the desired recess in the extension member 70a. The user 11 then releases the button 82a to allow the pin 86a to engage with the desired recess in the extension member 70a and to lock the extension member 70a into position. To further secure the extension member 70a to the locking mechanism 74a, the user 11 clasps the friction clamp 78a. The height adjustment system 34b may function similarly to the height adjustment system 34a to selectively couple the intermediate extension member 70a to the second extension member 70b at a desired relative position of the second extension member 70b with respect to the intermediate extension member 70a to obtain a desired height H of the tool attachment member 42 with respect to the support surface 12.

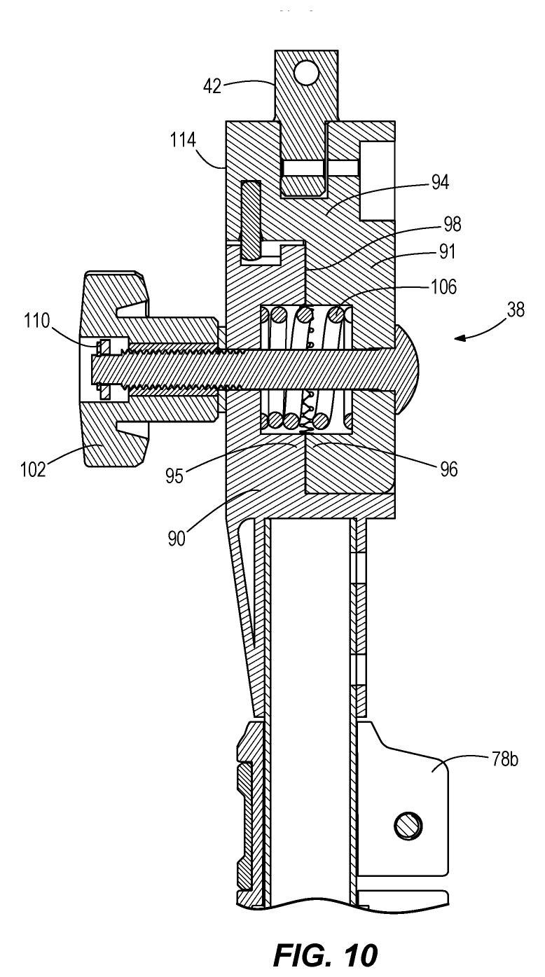

With reference to FIGS. 9 and 10, the top pivot joint 38 couples the head 114 to the second extension member 70b. The top pivot joint 38 includes a lower (i.e., first) joint body 90 attached to the second extension member 70b and an upper (i.e., second) joint body 91 attached to the housing 94 of the head 114. The first joint body 90 and the second joint body 91 may be attached to each other at a hirth joint 98 to allow the head 114 to pivot relative to the first joint body 90. In other words, the top pivot joint 38 may include a hirth joint. In some embodiments, the top pivot joint 38 may include teeth, and in some embodiments, the top pivot joint 38 may not include teeth. More specifically, in some embodiments, the top pivot joint 38 may include a friction joint having teeth, and in some embodiments, the top pivot joint 38 may include a friction joint not having teeth. Pivoting the housing 94 of the head 114 also acts to pivot the tool attachment member 42 (and, accordingly, the cable puller 14 (FIG. 1) when the cable puller 14 is attached to the tool attachment member 42) relative to the support surface 12. The hirth joint 98 includes a first joint member 95 integrally formed with first joint body 90 and attached to the second extension member 70b and a second joint member 96 integrally formed with the second joint body 91 and attached to the housing 94. The faces of the first joint member 95 and the second joint member 96 include triangular teeth that are selectively engaged with each other at a plurality of possible angles to select an angular position of the tool attachment member 42 relative to the second extension member 70b and, accordingly, to the height adjustment system 34a, 34b.

With continued reference to FIGS. 9 and 10, the top pivot joint 38 includes a hand knob 102 that allows a user to pivot the housing 94 relative to the first joint body 90 without the use of a tool. Turning the hand knob 102 in a first direction loosens the hirth joint 98. When the hirth joint 98 is loosened, a spring 106 positioned in the hirth joint 98 self-separates and pushes the first joint member 95 and the second joint member 96 apart such that they are disengaged. When the joint members 95, 96 are disengaged, the second joint member 96, which is attached to the housing 94, can be rotated relative to the first joint member 95, which is attached to the second extension member 70b. Once the second joint member 96 is rotated to the desired position, the user 11 can turn the hand knob 102 in a second direction to tighten the hirth joint 98 and engage the first and second joint members 95, 96 and to lock the hirth joint 98 in place. The hand knob 102 may include a travel limit retaining ring 110 which limits the rotation of the hand knob 102. The retaining ring 110 may inhibit the top pivot joint 38 from disassembling.

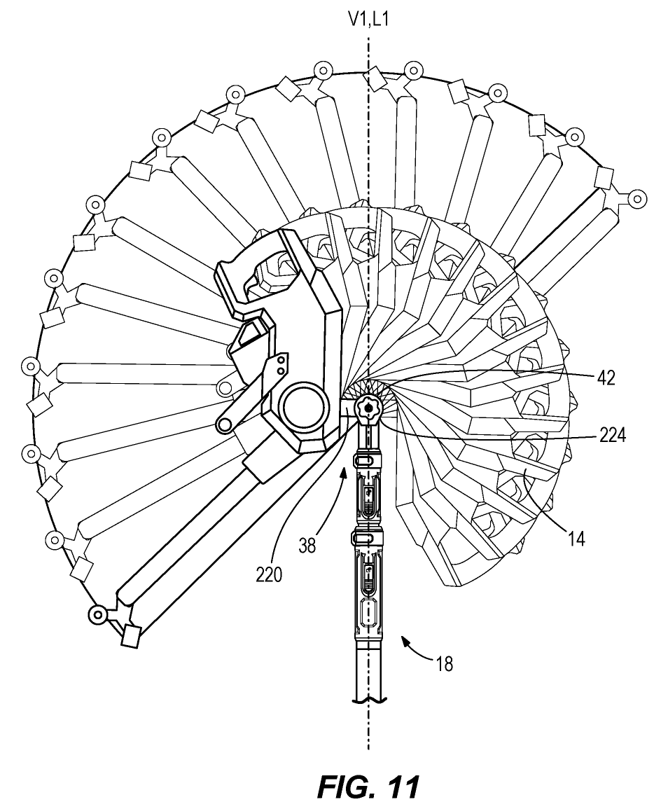

With reference to FIG. 11, the top pivot joint 38 allows the head 114 to pivot relative to the ground and pivot relative to a vertical axis V1 that may extend through the extension members 69, 70a, 70b. In some configurations, the vertical axis V1 may be collinear with a longitudinal axis L1 of the stand 18. The top pivot joint 38 allows the stand 18 to pivot in the first plane that is perpendicular to the ground. The top pivot joint 38 and the bottom pivot joint 30 may rotate in the same plane. The top pivot joint 38 may allow the tool attachment member 42 to have a pivot range (i.e., a pivot range between a first extreme position 220 and a second extreme position 224) of 180 degrees or approximately 180 degrees. The top pivot joint 38 may allow the tool attachment member 42 to pivot a first amount in a counterclockwise direction toward the first extreme position 220 from the longitudinal axis L1 of the stand 18 and a second amount in a clockwise direction toward the second extreme position 224 from the longitudinal axis L1 of the stand 18. The first pivot amount in the clockwise direction may be smaller than the second pivot amount in the counterclockwise direction, or vice versa. The top pivot joint 38 may have a set pivot resolution value, such that the user is able to pivot the top pivot joint 38 in set increments. The top pivot joint 38 may have a resolution of 15 degrees such that the user can rotate the top pivot joint 38 in 15-degree increments. In some embodiments, the top pivot joint 38 may be continuously adjustable.

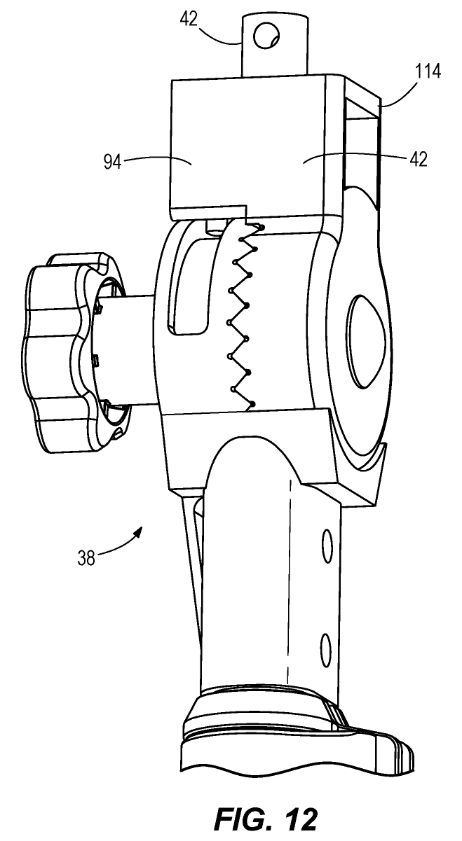

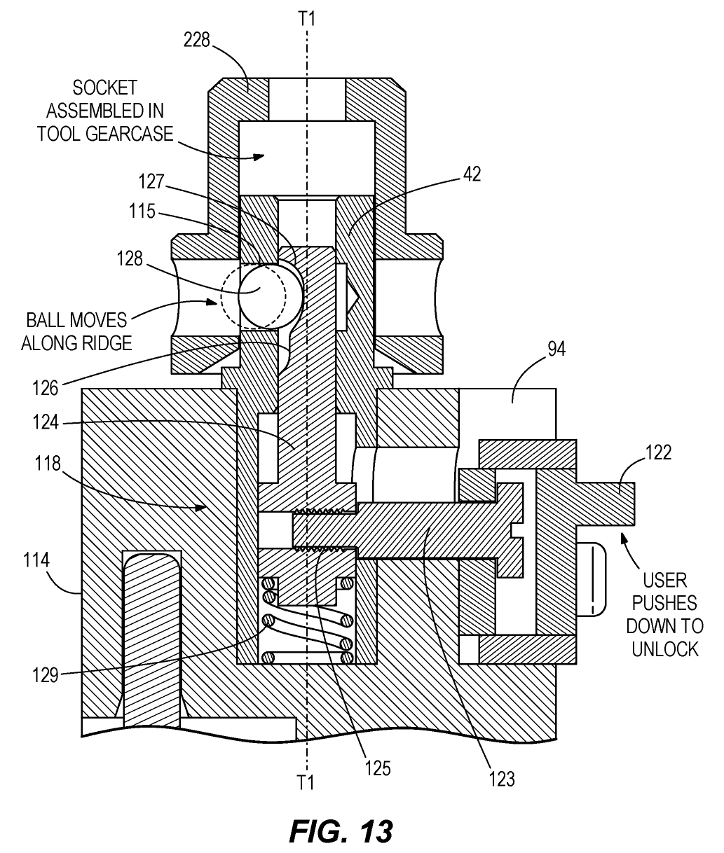

With reference to FIGS. 12 and 13, a head 114 of the stand 18 is located at the top end 26 of the stand 18 and includes a tool attachment system that may function similarly to a locking mechanism for coupling a socket to a ratchet. The head 114 includes the tool attachment member 42, the housing 94, and a locking mechanism 118. A socket 228 may be assembled in the tool gearcase of the cable puller 14 (FIG. 1) and configured to engage with the tool attachment member 42 to releasably attach the cable puller 14 to the stand 18. The socket 228 and the tool attachment member 42 may engage each other along a tool engagement axis T1. The tool attachment member 42 may extend vertically from the housing 94 when the housing 94 is not pivoted with respect to the longitudinal axis L1 of the stand 18 and the longitudinal axis L1 is oriented along the vertical axis V1. More specifically, when the housing 94 is not pivoted with respect to the longitudinal axis L1 of the stand 18, the tool engagement axis T1 is parallel to or, in some embodiments, collinear with the longitudinal axis L1 of the stand 18. The socket 228 may be positioned around the tool attachment member 42 to attach the cable puller 14 to the stand 18. The locking mechanism 118 includes an actuator 122 (e.g., a lever 122, a button 122, etc.), a first transmission member 123 (e.g, a lateral or transverse transmission member), a second transmission member 124 (e.g., a longitudinal transmission member), and a spring 129 (which may be referred to as a locking mechanism spring 129). The first transmission member 123 engages with the second transmission member 124 at a transmission interface 125, which may be a threaded interface 125, a pinned interface, or another type of interface. The second transmission member 124 includes a shallow recess 126 and a deeper recess 127 (i.e., a deeper recess than the shallow recess 126). The shallow recess 126 is adjacent to the deeper recess 127. More specifically, the shallow recess 126 is positioned on a side of the deeper recess 127 configured to be closer to the top pivot joint 38 than to the socket 228. The actuator 122 is operable to move a detent 128 that is positioned in the tool attachment member 42 of the tool attachment member 42 between a locked position and an unlocked position (shown in FIG. 13). The spring 129 biases the detent 128 toward the locked position by biasing the second transmission member 124 toward the locked position. In the locked position, the second transmission member 124 may be positioned closer to the socket 228 (i.e., further away from the top pivot joint 38) relative to a position of the second transmission member 124 in the unlocked position. In the locked position, the detent 128 is received in the shallow recess, and in the unlocked position, the detent 128 is positioned in the deeper recess 127. The detent 128 may be a detent ball 128. In the locked position, the detent ball 128 may be positioned in the tool attachment member 42 and extend into the socket 228 to limit movement of the socket 228 (i.e., a longitudinal movement of the socket 228) relative to the tool attachment member 42. In the unlocked position, the detent ball 128 is received in a cavity 115 of the tool attachment member 42 such that the socket 228 is longitudinally movable relative to the tool attachment member 42.

With continued reference to FIGS. 12 and 13, in operation, the tool attachment member 42 cooperates with the socket 228 to allow a user to selectively attach or remove the cable puller 14 from the stand 18. The user may operate the tool attachment member 42 by actuating the actuator 122 (e.g., by pressing down on the button 122) of the locking mechanism 118, thereby allowing the detent 128 to recede into the deeper recess 127 and causing the detent 128 to recede into the cavity 115 of the tool attachment member 42 such that the cable puller 14 can be removed from the tool attachment member 42 and thus the stand 18.

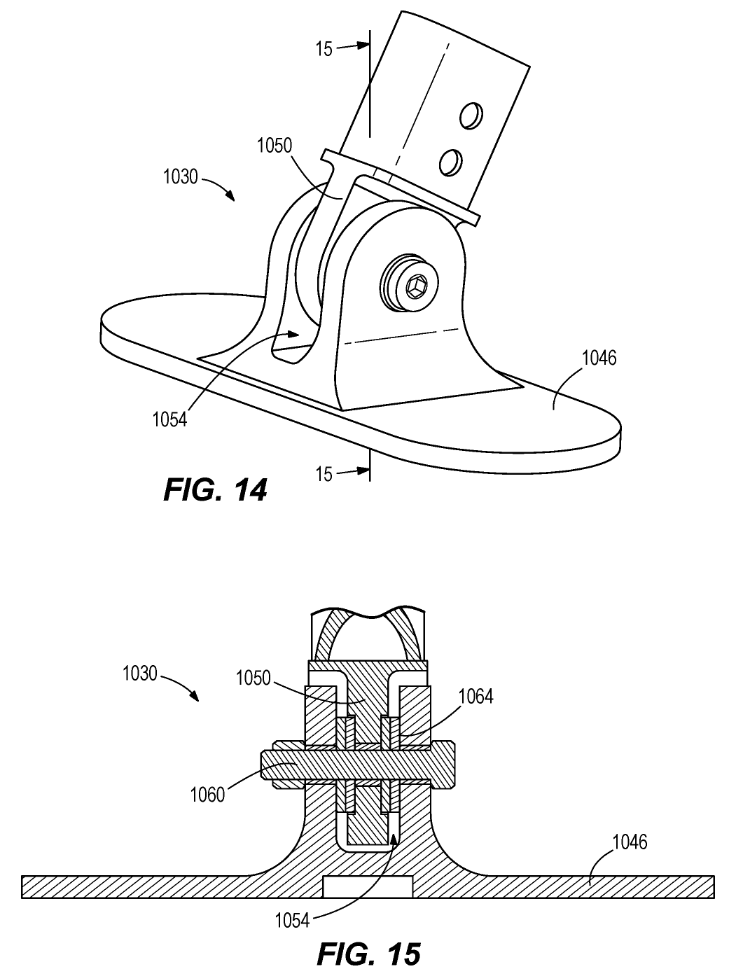

With reference to FIGS. 14-16, another embodiment of a bottom pivot joint 1030 (e.g., a first pivot joint) includes a foot 1046 such as a foot plate 1046 and a pivot body 1050 received within an opening 1054 of the foot plate 1046. The pivot body 1050 is secured to the foot plate 1046 by an axle 1060 (e.g., a bolt) that extends through the opening 1054 of the foot plate 1046 and the pivot body 1050. Bushings and/or thrust washers 1064 support the axle 1060. When the axle 1060 is loosened, the pivot body 1050 can be rotated relative to the foot plate 1046. The axle 1060 may be a double-shear pin (i.e., a pin or axle subjected to double shear) as shown in FIGS. 14 and 15 such that the bottom pivot joint 1030 is not cantilevered. The axle 1060 may be a threaded bolt 1060 including a nut that is tightened to a desired torque to provide a desired resistance to rotation of the pivot body 1050 relative to the foot plate 1046.

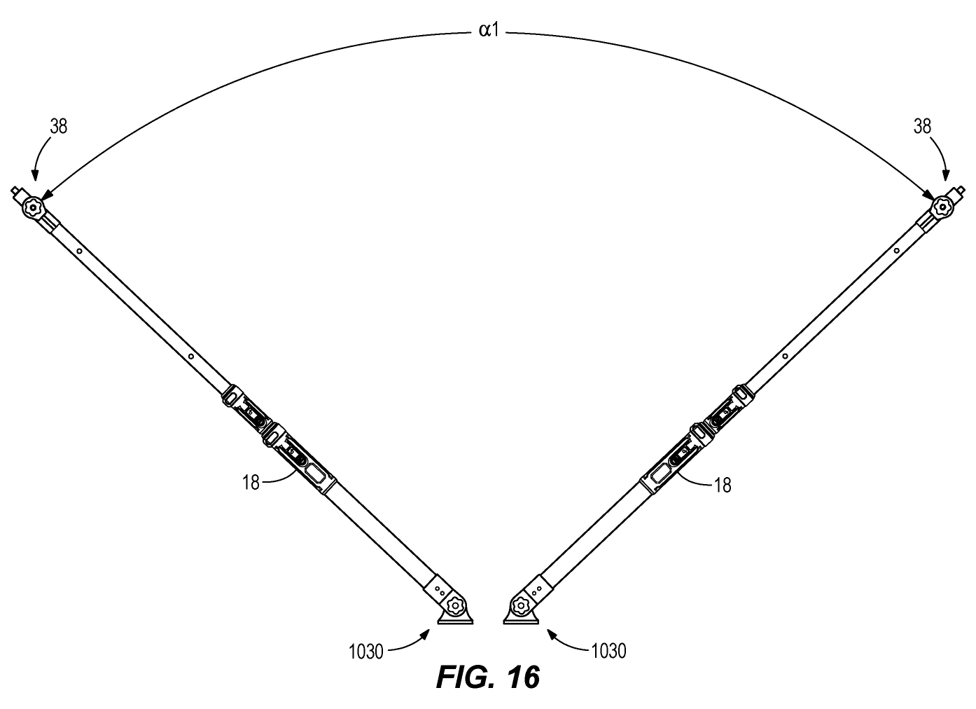

With continued reference to FIG. 16, the bottom pivot joint 1030 allows the stand 18 to pivot relative to the ground. More specifically, the bottom pivot joint 1030 allows the stand 18 to pivot on the first plane perpendicular to the ground and to the foot plate 1046. The bottom pivot joint 1030 rotates in the same plane as the top pivot joint 38. The bottom pivot joint 1030 may allow the stand 18 to have a pivot range α1 of 90 degrees. The bottom pivot joint 1030 may allow the stand 18 to pivot 45 degrees in a clockwise direction and 45 degrees in a counterclockwise direction. The bottom pivot joint 1030 may be smoothly and continuously pivoted to any position within the range of motion. More specifically, the bottom pivot joint 1030 may be a continuously adjustable or infinitely adjustable joint. In some embodiments, the top pivot joint 38 may be constructed similarly to the bottom pivot joint 30 (i.e., as a continuously adjustable joint having a double-shear axle).

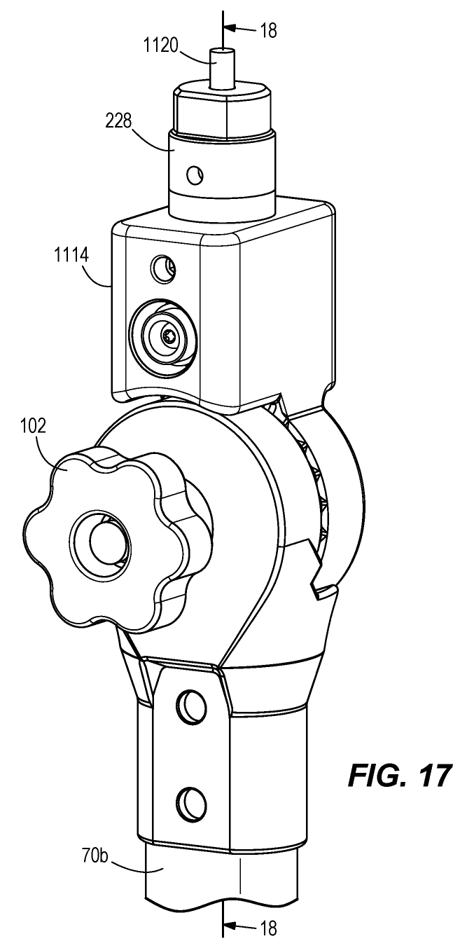

With reference to FIGS. 17-19, another embodiment of the stand 18 may include a head 1114, rather than the head 114 described with reference to FIGS. 12 and 13, at the top end 26 of the stand 18. The head 1114 includes the tool attachment member 42, a housing 1194, and a locking mechanism 1118. The housing 1194 may at least partially enclose the locking mechanism 1118. The head 1114 may include a tool attachment system that is different from the tool attachment system included in the head 114. More specifically, the locking mechanism 1118 may be different from the locking mechanism 118. The locking mechanism 1118 may selectively fasten the socket 228 to the tool attachment member 42 with the detent 128 (e.g., a detent ball 128). The socket 228 may be attached to a remainder of the cable puller 14 via a fastener 1120 such as a screw 1120. The socket 228 is configured to engage with the tool attachment member 42 to releasably attach the cable puller 14 to the stand 18.

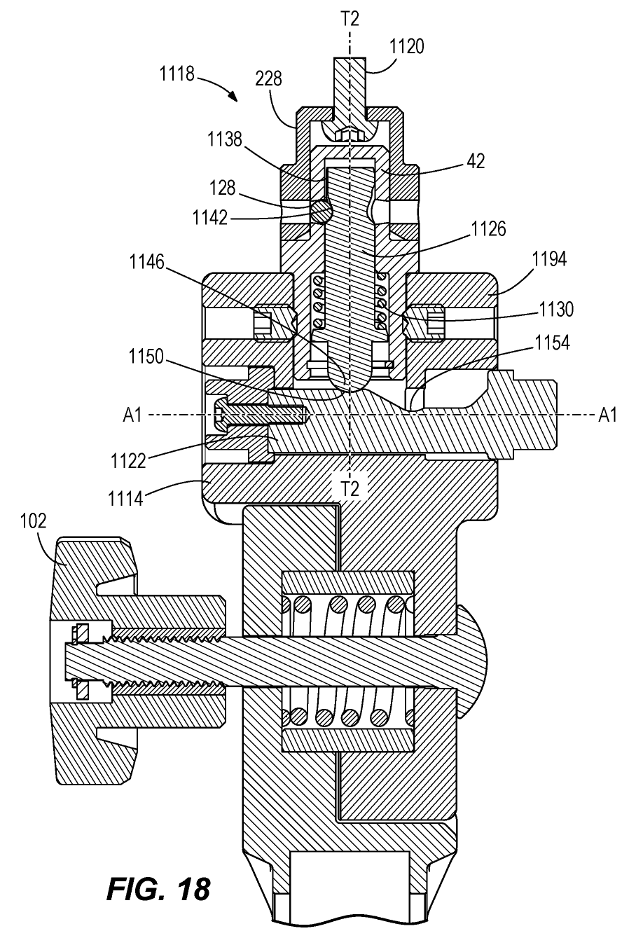

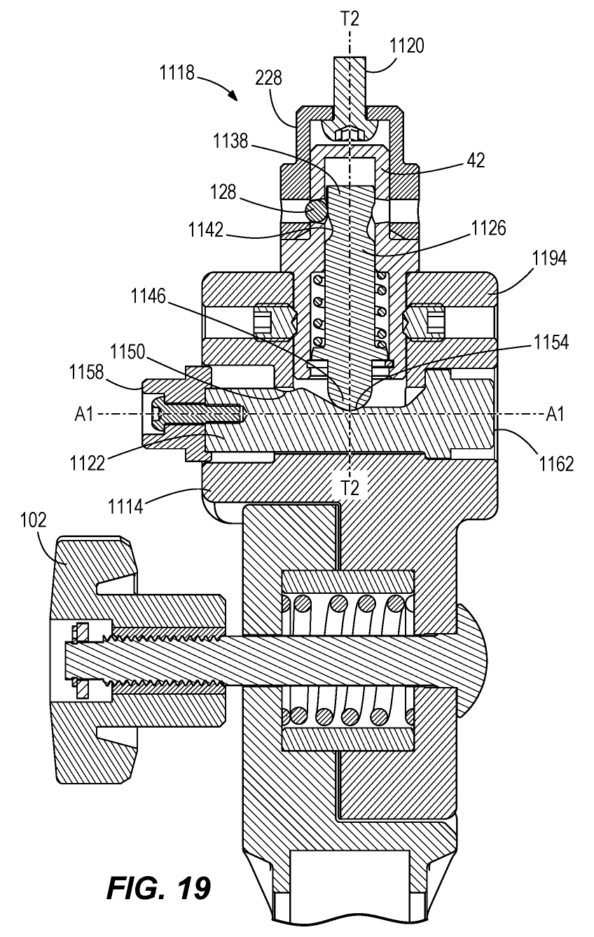

With continued reference to FIGS. 18 and 19, the socket 228 and the tool attachment member 42 may engage each other along a tool engagement axis T2. Similar to the configuration of the tool attachment member 42 and the housing 94 described elsewhere herein, the tool attachment member 42 may extend vertically from the housing 1194 when the housing 1194 is not pivoted with respect to the longitudinal axis L1 of the stand 18 and the longitudinal axis L1 is oriented along the vertical axis V1. More specifically, when the housing 1194 is not pivoted with respect to the longitudinal axis L1 of the stand 18, the tool engagement axis T2 is parallel to or, in some embodiments, collinear with the longitudinal axis L1 of the stand 18. The socket 228 may be positioned around the tool attachment member 42 to attach the cable puller 14 to the stand 18.

With continued reference to FIGS. 18 and 19, the locking mechanism 1118 includes a transverse slide 1122 (e.g., a lateral slide) that slides transversely (e.g., transversely or perpendicularly with respect to the tool engagement axis T2). The locking mechanism 1118 is selectively positionable in an unlatched or unlocked position (FIG. 18) or in a latched or locked position (FIG. 19). The locking mechanism 1118 includes a longitudinal slide 1126 that moves along the tool engagement axis T2 between the unlatched or unlocked position (FIG. 18) and the latched or locked position (FIG. 19). The longitudinal slide 1126 includes a first end 1138 having a detent recess 1142 that receives the detent 128. The detent 128 contacts the longitudinal slide 1126. The detent recess 1142 may include a shallow recess 126 and a deeper recess 127 as described elsewhere herein to selectively receive the detent 128. The longitudinal slide 1126 includes a second end 1146 opposite the first end 1138. The second end 1146 engages the transverse slide 1122. The second end 1146 may include a rounded surface that fits within one or more corresponding recesses provided in the transverse slide 1122. The locking mechanism 1118 includes one or more springs 1130 biasing the longitudinal slide 1126 toward the transverse slide 1122 and/or toward the locked position (FIG. 19). In the illustrated embodiment, the longitudinal slide 1126 is biased toward the transverse slide 1122 and toward the locked position. The one or more springs 1130 surround the longitudinal slide 1126. In some embodiments, the one or more springs 1130 may be coaxial with the longitudinal slide 1126. In some embodiments, the one or more springs 1130 may be coaxial with the tool engagement axis T2.

With continued reference to FIGS. 18 and 19, the transverse slide 1122 moves along a transverse slide axis A1 that is transverse (e.g., perpendicular) to the movement axis of the longitudinal slide 1126 (the tool engagement axis T2 in the illustrated embodiment). The transverse slide 1122 includes a first recess 1150 (e.g., an unlocked recess 1150) in which the second end 1146 of the longitudinal slide 1126 is received when the detent 128 is not locked to the socket 228. The transverse slide 1122 includes a second recess 1154 (e.g., a locked recess 1154) in which the second end 1146 of the longitudinal slide 1126 is received when the detent 128 is locked to the socket 228 (i.e., when the socket 228 is locked to the tool attachment member 42).

In operation, and with continued reference to FIGS. 18 and 19, a position of the longitudinal slide 1126 determines a position of the detent 128, which engages the socket 228 of a power tool (e.g., the cable puller 14). A user may push on a first end 1158 of the transverse slide 1122 to move the transverse slide 1122 along the axis A1 to shift the locking mechanism 1118 from the locked position to the unlocked position, and the user may push on a second end 1162 of the transverse slide 1122 (opposite from the first end 1158) to move the transverse slide 1122 along the axis A1 in an opposite direction to shift the locking mechanism 1118 from the unlocked position to the locked position.

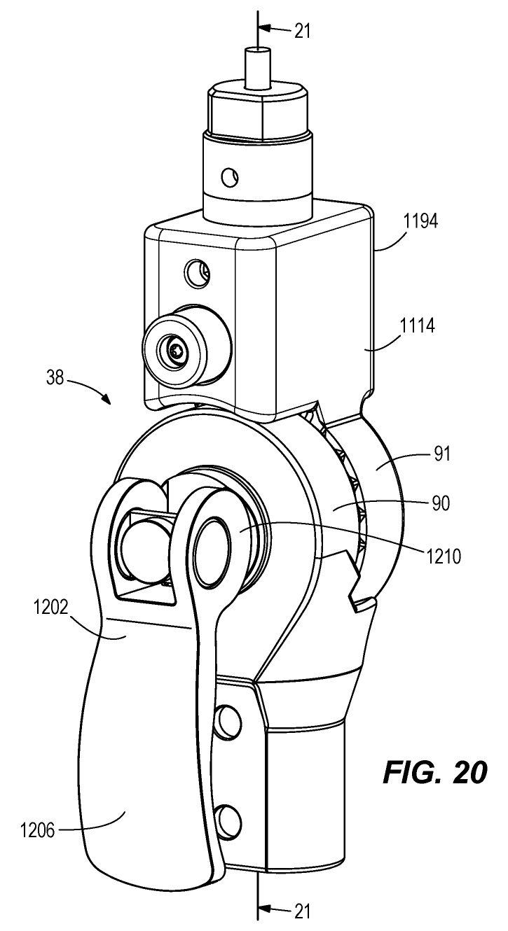

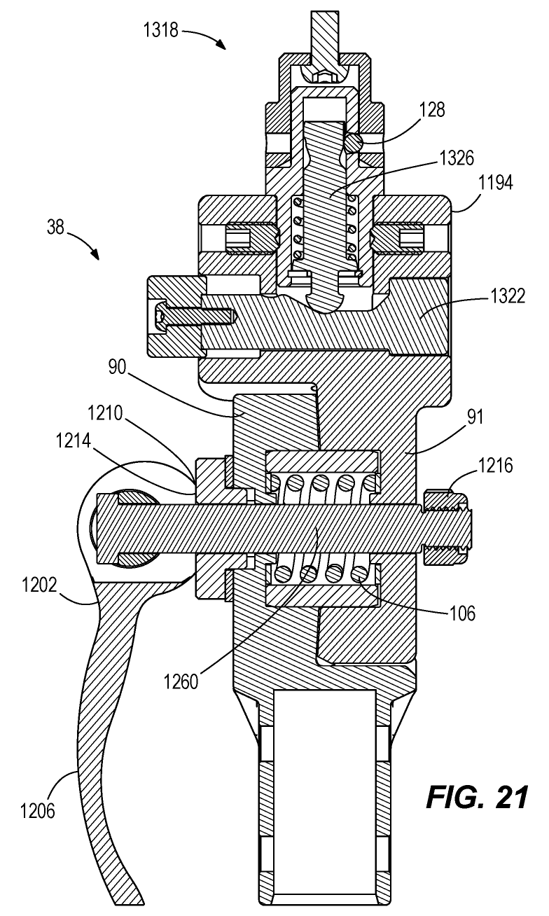

With reference to FIGS. 20 and 21, in some embodiments, the top pivot joint 38 may include a cam handle 1202 in place of the hand knob 102 for selectively securing the top pivot joint 38 in a desired position. The cam handle 1202 includes a grip portion 1206 and a cam lobe 1210. The cam handle 1202 allows a user to selectively pivot the housing 1194 relative to the first joint body 90 when the cam handle 1202 is in a released position and to select a desired relative position of the housing 1194 and the first joint body 90 at which to fix the top pivot joint 38 without the use of a tool. More specifically, placing the cam handle 1202 in the position shown in FIGS. 20 and 21, which may be parallel or generally parallel to the extension members 69, 70a, 70b, clamps the first joint body 90 to the second joint body 91 together to inhibit the head 1114 from pivoting relative to the first joint body 90. The grip portion 1206 is manipulatable by the user to selectively cause the cam lobe 1210 to bear against a bearing surface 1214 to place an axle 1260 in tension so that the first joint body 90 and the second joint body 91 are selectively clamped together between the cam lobe 1210 and an opposite bearing component such as a nut 1216 that is attached to the axle 1260. The cam handle 1202 may be rotated from a clamped position, shown in FIGS. 20 and 21, to a released position (e.g., a position in which the grip portion 1206 is transverse or parallel to the extension members 69, 70a, 70b) in which the first joint body 90 and the second joint body 91 are rotatable relative to each other about the axle 1260. In the released position, the spring 106 causes the top pivot joint 38 to self-separate to disengage the first joint body 90 from the second joint body 91.

With continued reference to FIG. 21, a locking mechanism 1318 may be similar to the locking mechanism 1118 except as described herein and/or as is apparent from the figures. The locking mechanism 1318 includes a detent 128, a longitudinal slide 1326 (similar in some respects to the longitudinal slide 1126) that engages the detent 128, and a transverse slide 1322 (similar in some respects to the transverse slide 1122). The transverse slide 1322 includes recesses for receiving the longitudinal slide 1326 as described elsewhere herein with respect to the locking mechanism 1118.

Aspect 1. A stand for use with a power tool, the stand comprising: a first end and a second end opposite the first end; a foot positioned at the first end of the stand, the foot configured to rest on a support surface; a head positioned at the second end of the stand, the head including a tool attachment member defining a tool engagement axis, the tool attachment member configured to selectively couple to the power tool along the tool engagement axis such that the stand supports the power tool at a height with respect to the foot; a first extension member coupled to the foot; and a second extension member coupled to the first extension member and extending away from the first extension member, the second extension member being selectively extendable and retractable with respect to the first extension member.

Aspect 2. The stand of aspect 1, further comprising a pivot joint positioned between the first extension member and the foot or positioned between the second extension member and the head, the pivot joint configured to selectively adjust a position of the head and/or an angle of the tool engagement axis relative to the foot.

Aspect 3. The stand of aspect 2, wherein: the pivot joint is a first pivot joint, the first pivot joint is positioned between the first extension member and the foot, and the stand includes a second pivot joint positioned between the second extension member and the head.

Aspect 4. The stand of aspect 2, wherein the pivot joint includes a hirth joint, a hand knob, and a spring, the spring positioned within the hirth joint such that the hirth joint self-separates when the hand knob is loosened.

Aspect 5. The stand of aspect 2, wherein the pivot joint includes a friction joint having teeth.

Aspect 6. The stand of aspect 2, wherein the pivot joint includes a friction joint having no teeth.

Aspect 7. The stand of aspect 2, wherein: the pivot joint includes a pivot body that is secured to the foot by an axle subjected to double shear, the axle is supported by bushings and/or thrust washers, and the pivot joint is continuously adjustable.

Aspect 8. The stand of aspect 2, wherein the pivot joint is cantilevered.

Aspect 9. The stand of aspect 1, further comprising an intermediate extension member interposed between the first extension member and the second extension member, wherein the intermediate extension member is selectively extendable and retractable relative to the first extension member, and wherein the second extension member is selectively extendable and retractable relative to the intermediate extension member.

Aspect 10. The stand of aspect 9, wherein: the stand is a telescoping tube stand, the first extension member is a first tube, the second extension member is a second tube, and the intermediate extension member is an intermediate tube, the intermediate tube configured to telescope with respect to the first tube, and the second tube configured to telescope with respect to the intermediate tube.

Aspect 11. The stand of aspect 1, wherein: the second extension member includes a plurality of recesses, and the stand includes a pin configured to selectively engage the recesses to selectively lock the second extension member at a desired position relative to the first extension member.

Aspect 12. The stand of aspect 11, further comprising a friction clamp configured to selectively clasp the second extension member to inhibit rattling of the second extension member, wherein the particular recess of the plurality of recesses in which the pin is engaged is selectable to determine the height of the power tool relative to the foot.

Aspect 13. The stand of aspect 12, wherein: the plurality of recesses is a plurality of second recesses, the pin is a second pin; the friction clamp is a second friction clamp, the stand includes an intermediate extension member interposed between the first extension member and the second extension member, wherein the intermediate extension member is selectively extendable and retractable relative to the first extension member, and wherein the second extension member is selectively extendable and retractable relative to the intermediate extension member, the intermediate extension member includes a plurality of intermediate recesses, the stand includes an intermediate pin configured to selectively engage the plurality of intermediate recesses to selectively lock the intermediate extension member at a desired position relative to the first extension member, the stand includes an intermediate friction clamp configured to selectively clasp the intermediate extension member to inhibit rattling of the intermediate extension member, and the particular intermediate recess of the plurality of intermediate recesses in which the intermediate pin is engaged is selectable to determine the height of the power tool relative to the foot.

Aspect 14. The stand of aspect 1, wherein: the head includes a housing and a locking mechanism, the locking mechanism positionable in a locked position and in an unlocked position, the locking mechanism includes an actuator, a first transmission member, a second transmission member, and a locking mechanism spring, the locking mechanism spring biases the second transmission member toward the locked position, the second transmission member includes a shallow recess and a deeper recess, in the locked position, a detent ball is received in the shallow recess, and in the unlocked position, the detent ball is received in the deeper recess.

Aspect 15. A stand for a power tool, the stand comprising: a first end and a second end opposite the first end; a foot positioned at the first end of the stand, the foot configured to rest on a support surface; a first extension member coupled to the foot and extending away from the foot; a second extension member coupled to the first extension member and extending away from the first extension member, the second extension member being selectively moveable and lockable with respect to the first extension member; and a head coupled to the second extension member and positioned at the second end of the stand, the head including a tool attachment member defining a tool engagement axis, the tool attachment member configured to selectively couple to the power tool along the tool engagement axis such that the stand supports the power tool at a height with respect to the support surface.

Aspect 16. The stand of aspect 15, further comprising an intermediate extension member coupled to the first extension member and extending away from the first extension member, the intermediate extension member being selectively extendable and retractable with respect to the first extension member, wherein the second extension member is coupled to the intermediate extension member and extends away from the intermediate extension member, the second extension member being selectively extendable and retractable with respect to the intermediate extension member, wherein the second extension member is selectively extendable and retractable with respect to the first extension member.

Aspect 17. The stand of aspect 16, wherein: the intermediate extension member includes a plurality of intermediate recesses, an intermediate pin is configured to selectively engage the intermediate recesses to selectively lock the intermediate extension member at a desired intermediate position relative to the first extension member to select a desired height of the tool attachment member relative to the foot, an intermediate friction clamp is configured to selectively clasp the intermediate extension member to inhibit rattling of the intermediate extension member, the second extension member includes a plurality of second recesses, a second pin is configured to engage the second recesses to selectively lock the second extension member at a desired second position relative to the intermediate extension member, and a second friction clamp is configured to selectively clasp the second extension member to inhibit rattling of the second extension member.

Aspect 18. The stand of aspect 15, further comprising a battery-powered cable puller couplable to the tool attachment member, the battery-powered cable puller including a socket and a tool housing, the tool housing at least partially defining a battery receptacle configured to receive an interchangeable battery pack selectively usable with a power tool, the socket configured to engage the tool attachment member to releasably couple the battery-powered cable puller to the head, wherein the battery-powered cable puller includes a gearcase, and wherein the socket is assembled in the gearcase of the battery-powered cable puller.

Aspect 19. The stand of aspect 15, wherein the stand further comprises a first pivot joint closer to the first end than to the second end and a second pivot joint closer to the second end than to the first end, and wherein the first pivot joint and the second pivot joint are operable to select an angle of the tool engagement axis relative to the support surface.

Aspect 20. The stand of aspect 15, wherein the stand further comprises a pivot joint closer to the first end than to the second end, and wherein the pivot joint is operable to select an angle of the tool engagement axis relative to the support surface.

Aspect 21. The stand of aspect 15, wherein the stand further comprises a pivot joint closer to the second end than to the first end, and wherein the pivot joint is operable to select an angle of the tool engagement axis relative to the support surface.

Aspect 22. The stand of aspect 15, wherein: the head includes a housing and a locking mechanism, the locking mechanism positionable in a locked position and in an unlocked position, the locking mechanism includes an actuator, a first transmission member, a second transmission member, and a locking mechanism spring, the locking mechanism spring biases the second transmission member toward the locked position, the second transmission member includes a shallow recess and a deeper recess, in the locked position, a detent ball is received in the shallow recess, and in the unlocked position, the detent ball is received in the deeper recess.

Aspect 23. A stand for a power tool, the stand comprising: a first end and a second end opposite the first end; a foot positioned at the first end of the stand, the foot configured to rest on a support surface; a first pivot joint closer to the first end than to the second end; an extension pole coupled to the foot via the first pivot joint such that the extension pole is selectively pivotable relative to the foot; a second pivot joint closer to the second end than to the first end; and a head coupled to the extension pole via the second pivot joint such that the head is selectively pivotable relative to the extension pole, the head including a tool attachment member defining a tool engagement axis, the tool attachment member configured to selectively couple to the power tool along the tool engagement axis such that the stand supports the power tool at a height with respect to the support surface, wherein the first pivot joint and the second pivot joint are operable to select a position of the tool attachment member and an angle of the tool engagement axis relative to the foot.

Aspect 24. The stand of aspect 23, further comprising a battery-powered cable puller including a tool housing, the tool housing at least partially defining a battery receptacle configured to receive an interchangeable battery pack selectively usable with a power tool, the battery-powered cable puller including a socket couplable to the tool attachment member, wherein: the head includes a housing and a locking mechanism, the locking mechanism positionable in a locked position and in an unlocked position, the locking mechanism includes an actuator, a first transmission member, a second transmission member, and a locking mechanism spring, the locking mechanism spring biases the second transmission member toward the locked position, the second transmission member includes a shallow recess and a deeper recess, in the locked position, a detent ball is received in the shallow recess, and in the unlocked position, the detent ball is received in the deeper recess.

Aspect 25. The stand of aspect 23, wherein the first pivot joint permits the stand to have a pivot range of approximately 90 degrees between a first extreme position and a second extreme position, the first extreme position being a position of maximum rotation in a first direction, the second extreme position being a position of maximum rotation in a second direction, the second direction being opposite the first direction, and the second direction being in a same plane as the first direction.

Aspect 26. The stand of aspect 23, wherein the first pivot joint has a pivot resolution value of approximately 15 degrees between a first extreme position and a second extreme position, the first extreme position being a position of maximum rotation in a first direction, and the second extreme position being a position of maximum rotation in a second direction.

Aspect 27. The stand of aspect 23, wherein the first pivot joint is continuously adjustable.

Aspect 28. A stand for a power tool, the stand comprising: a first end and a second end opposite the first end; a foot positioned at the first end of the stand, the foot configured to rest on a support surface; a first extension member coupled to the foot and extending away from the foot; a second extension member coupled to the first extension member and extending away from the first extension member, the second extension member being selectively extendable and retractable with respect to the first extension member; and a head coupled to the second extension member and positioned at the second end of the stand, the head including a tool attachment member defining a tool engagement axis along which a socket of the power tool engages the tool attachment member, the tool attachment member configured to selectively couple to the power tool along the tool engagement axis such that the stand supports the power tool at a height with respect to the support surface, the head including a housing at least partially enclosing a locking mechanism positionable in a locked position and in an unlocked position, the locking mechanism including: a longitudinal slide configured to slide parallel to the tool engagement axis, and a transverse slide configured to slide transverse to the tool engagement axis to selectively position the longitudinal slide in the locked position or the unlocked position.

Aspect 29. The stand of aspect 28, wherein the transverse slide is configured to slide perpendicular to the tool engagement axis.

Aspect 30. The stand of aspect 28, wherein the locking mechanism includes a spring configured to bias the longitudinal slide toward the transverse slide.

Aspect 31. The stand of aspect 28, wherein the locking mechanism includes a detent ball configured to contact the longitudinal slide, the detent ball configured to selectively lock the socket of the power tool in the locked position according to a position of the transverse slide.

Although the invention has been described in detail with reference to certain preferred embodiments, variations and modifications exist within the scope and spirit of one or more independent aspects of the invention as described.

What is claimed is:

1. A stand for use with a power tool, the stand comprising:
a first end and a second end opposite the first end;
a foot positioned at the first end of the stand, the foot configured to rest on a support surface;
a head positioned at the second end of the stand, the head including a tool attachment member defining a tool engagement axis, the tool attachment member configured to selectively couple to the power tool along the tool engagement axis such that the stand supports the power tool at a height with respect to the foot;
a first extension member coupled to the foot; and
a second extension member coupled to the first extension member and extending away from the first extension member, the second extension member being selectively extendable and retractable with respect to the first extension member.

2. The stand of claim 1, further comprising a pivot joint positioned between the first extension member and the foot or positioned between the second extension member and the head, the pivot joint configured to selectively adjust a position of the head and/or an angle of the tool engagement axis relative to the foot.

3. The stand of claim 2, wherein:
the pivot joint is a first pivot joint,
the first pivot joint is positioned between the first extension member and the foot, and
the stand includes a second pivot joint positioned between the second extension member and the head.

4. The stand of claim 2, wherein the pivot joint includes a hirth joint, a hand knob, and a spring, the spring positioned within the hirth joint such that the hirth joint self-separates when the hand knob is loosened.

5. The stand of claim 2, wherein the pivot joint includes a friction joint having teeth.

6. The stand of claim 1, further comprising an intermediate extension member interposed between the first extension member and the second extension member, wherein the intermediate extension member is selectively extendable and retractable relative to the first extension member, and wherein the second extension member is selectively extendable and retractable relative to the intermediate extension member.

7. The stand of claim 6, wherein:
the stand is a telescoping tube stand,
the first extension member is a first tube,
the second extension member is a second tube, and
the intermediate extension member is an intermediate tube, the intermediate tube configured to telescope with respect to the first tube, and the second tube configured to telescope with respect to the intermediate tube.

8. The stand of claim 1, wherein:
the second extension member includes a plurality of recesses, and
the stand includes a pin configured to selectively engage the recesses to selectively lock the second extension member at a desired position relative to the first extension member.

9. The stand of claim 8, further comprising a friction clamp configured to selectively clasp the second extension member to inhibit rattling of the second extension member, wherein the particular recess of the plurality of recesses in which the pin is engaged is selectable to determine the height of the power tool relative to the foot.

10. The stand of claim 9, wherein:
the plurality of recesses is a plurality of second recesses,
the pin is a second pin;
the friction clamp is a second friction clamp,
the stand includes an intermediate extension member interposed between the first extension member and the second extension member, wherein the intermediate extension member is selectively extendable and retractable relative to the first extension member, and wherein the second extension member is selectively extendable and retractable relative to the intermediate extension member,
the intermediate extension member includes a plurality of intermediate recesses,
the stand includes an intermediate pin configured to selectively engage the plurality of intermediate recesses to selectively lock the intermediate extension member at a desired position relative to the first extension member,
the stand includes an intermediate friction clamp configured to selectively clasp the intermediate extension member to inhibit rattling of the intermediate extension member, and
the particular intermediate recess of the plurality of intermediate recesses in which the intermediate pin is engaged is selectable to determine the height of the power tool relative to the foot.

11. The stand of claim 1, wherein:
the head includes a housing and a locking mechanism, the locking mechanism positionable in a locked position and in an unlocked position,
the locking mechanism includes an actuator, a first transmission member, a second transmission member, and a locking mechanism spring,
the locking mechanism spring biases the second transmission member toward the locked position,
the second transmission member includes a shallow recess and a deeper recess,
in the locked position, a detent ball is received in the shallow recess, and
in the unlocked position, the detent ball is received in the deeper recess.

12. A stand for a power tool, the stand comprising:
a first end and a second end opposite the first end;
a foot positioned at the first end of the stand, the foot configured to rest on a support surface;
a first pivot joint closer to the first end than to the second end;
an extension pole coupled to the foot via the first pivot joint such that the extension pole is selectively pivotable relative to the foot;
a second pivot joint closer to the second end than to the first end; and
a head coupled to the extension pole via the second pivot joint such that the head is selectively pivotable relative to the extension pole, the head including a tool attachment member defining a tool engagement axis, the tool attachment member configured to selectively couple to the power tool along the tool engagement axis such that the stand supports the power tool at a height with respect to the support surface,
wherein the first pivot joint and the second pivot joint are operable to select a position of the tool attachment member and an angle of the tool engagement axis relative to the foot.

13. The stand of claim 12, further comprising a battery-powered cable puller including a tool housing, the tool housing at least partially defining a battery receptacle configured to receive an interchangeable battery pack selectively usable with a power tool, the battery-powered cable puller including a socket couplable to the tool attachment member, wherein:
the head includes a housing and a locking mechanism, the locking mechanism positionable in a locked position and in an unlocked position,
the locking mechanism includes an actuator, a first transmission member, a second transmission member, and a locking mechanism spring,
the locking mechanism spring biases the second transmission member toward the locked position,
the second transmission member includes a shallow recess and a deeper recess,
in the locked position, a detent ball is received in the shallow recess, and
in the unlocked position, the detent ball is received in the deeper recess.

14. The stand of claim 12, wherein the first pivot joint permits the stand to have a pivot range of approximately 90 degrees between a first extreme position and a second extreme position, the first extreme position being a position of maximum rotation in a first direction, the second extreme position being a position of maximum rotation in a second direction, the second direction being opposite the first direction, and the second direction being in a same plane as the first direction.

15. The stand of claim 12, wherein the first pivot joint has a pivot resolution value of approximately 15 degrees between a first extreme position and a second extreme position, the first extreme position being a position of maximum rotation in a first direction, and the second extreme position being a position of maximum rotation in a second direction.

16. The stand of claim 12, wherein the first pivot joint is continuously adjustable.

17. A stand for a power tool, the stand comprising:
a first end and a second end opposite the first end;
a foot positioned at the first end of the stand, the foot configured to rest on a support surface;
a first extension member coupled to the foot and extending away from the foot;
a second extension member coupled to the first extension member and extending away from the first extension member, the second extension member being selectively extendable and retractable with respect to the first extension member; and
a head coupled to the second extension member and positioned at the second end of the stand, the head including a tool attachment member defining a tool engagement axis along which a socket of the power tool engages the tool attachment member, the tool attachment member configured to selectively couple to the power tool along the tool engagement axis such that the stand supports the power tool at a height with respect to the support surface, the head including a housing at least partially enclosing a locking mechanism positionable in a locked position and in an unlocked position, the locking mechanism including:
a longitudinal slide configured to slide parallel to the tool engagement axis, and
a transverse slide configured to slide transverse to the tool engagement axis to selectively position the longitudinal slide in the locked position or the unlocked position.

18. The stand of claim 17, wherein the transverse slide is configured to slide perpendicular to the tool engagement axis.

19. The stand of claim 17, wherein the locking mechanism includes a spring configured to bias the longitudinal slide toward the transverse slide.

20. The stand of claim 17, wherein the locking mechanism includes a detent ball configured to contact the longitudinal slide, the detent ball configured to selectively lock the socket of the power tool in the locked position according to a position of the transverse slide.
